(19) United States
(12) Patent Application Publication
(10) Pub. No.: US 2014/0345897 A1
(43) Pub. Date: Nov. 27, 2014

(54) COMPOSITE MATERIALS SPINDLE

(71) Applicant: James Pelletier, Plainville, CT (US)

(72) Inventor: James Pelletier, Plainville, CT (US)

(73) Assignee: GROS-ITE PRECISION SPINDLE, Farmington, CT (US)

(21) Appl. No.: 14/283,608

(22) Filed: May 21, 2014

Related U.S. Application Data
(60) Provisional application No. 61/825,648, filed on May 21, 2013.

(51) Int. Cl. B23Q 5/04; G06F 17/50

(52) U.S. Cl. CPC B23Q 5/04; G06F 17/50
USPC 173/213; 703/7

(57) ABSTRACT

A spindle with a composite material spindle housing insert and a composite material spindle shaft insert is disclosed where housing characteristics of the housing insert are calculated to match the spindle characteristics of the spindle shaft to provide optimum spindle performance.

### FIELD OF THE INVENTION

The present invention relates generally to rotating spindles and particularly to deep holes spindles used for metal cutting, where the surface in which the material needed to be removed is in a deep hole, such that the ratio between the access opening dimension and the distance from such opening to the surface to be cut, is relatively small.

### BACKGROUND OF THE INVENTION

Spindles are well known in the art and generally are designed for use in metal cutting machining centers. Spindles have a front nose where typically a tool retention system is used to attach the material removing tool such as a grinding wheel or other traditional metal removing tools. Spindles include two main types, the motorized type and the non-motorized type. As the name implies, the motorized type typically includes a powered motor that is embedded into the spindle design and is immovable. On the other hand, the non-motorized type does not include a powered motor into the design but it requires an external power source to operate the spindle and is removable from the spindle itself. The major components that specify and define the decisive characteristics of a spindle are the spindle housing, which is typically mounted onto the machining center frame or on one of the machine center axis, the spindle shaft, which is typically the rotating part of the spindle, and the spindle bearings, which are the support between the fixed housing and the rotating shaft.

To date spindle housings and spindle shafts have been designed and developed using traditional materials such as steel, alloy steel, stainless steel, aluminum alloys, cast iron, and other structurally homogeneous materials. Unfortunately, current material designs have several disadvantages and limitations. One such disadvantage is that each of the metals has some advantageous characteristics which may improve the performance of the spindle in certain aspects but also generally does not have other characteristics important to the overall performance of the spindle.

The current state of the art is limited or completely ignores the important and influential effect of the behavior of one component in relation to the other components included in a spindle system. The reason for this limitation is the fact that one of the components of the spindle, either the housing or the shaft, was generally manufactured with traditional materials, such as steel. Simplifying the design by using only one material as a variable, the housing or the shaft, has a limiting effect on the overall spindle performance. Another limiting factor is the lack of tailoring the traditional material to fit the characteristics and behavior of the new composite material component and therefore restraining the overall performance of the spindle. The magnitude of this inadequacy is easily measurable and is substantially vast.

Since each of the traditional materials do not have all the mechanical characteristics needed to achieve a superior performance spindle, engineers are required to compromise the design in order to provide the best performance obtainable with traditional materials. For example the use of high strength alloy steel, instead of an aluminum alloy, may improve the stiffness in the design but it will also add weight to the spindle which is not desirable due to increased inertia, increased static deflection, reduced vibration dampening and limited control over the natural frequency ranges. Thus, it is desirable to make an improved version of a spindle housing and a spindle shaft, where the materials are engineered and tailored to obtain the maximum performance while at the same time providing light weight, reduced inertia, improved stiffness, improved vibration dampening, improved control of the natural frequency ranges

### SUMMARY OF THE INVENTION

A composite materials spindle is provided, which includes a spindle housing made with composite materials, a spindle shaft made with composite materials, a set of bearings located in the front of the spindle, and a set of bearings located on the back of the spindle. The composite materials spindle may or may not include a powered embedded motor that is immovable. Other auxiliary accessories are part of the spindle assembly but they do not affect the present invention. Those such parts are the front cap, the rear cap, the front and rear seal, and the bearing inner and outer spacers. Also other auxiliary accessory parts may be included or not in the spindle assembly such as bearings preload springs, encoders, tool retention drawbars, electronic sensors and other accessories. The invention provides for a method for manufacturing and assembling the composite materials spindle housing and spindle shaft, wherein the composite materials are selected and designed to improve specific characteristics of the spindle.

### BRIEF DESCRIPTION OF THE DRAWINGS

The features and advantages of the present invention should be more fully understood with the following drawings:

FIG. 1a is an isometric view of an improved composite materials spindle assembly, in accordance with the present invention.

FIG. 1b is front view of the composite materials spindle assembly of FIG. 1a.

FIG. 1c is a side section view of the composite materials spindle assembly of FIG. 1b.

FIG. 2 shows a flowchart of how an optimized housing and shaft are analyzed together for improving the two by matching thermal expansion and matching natural frequencies.

FIG. 3 shows a flowchart of how an optimized housing and shaft are analyzed together for improving the two by reducing weight and improving overall stiffness.

FIG. 4 shows a flowchart of how an optimized housing and shaft are analyzed together for improving the two by improving overall dampening and natural frequency ranges.

### DETAILED DESCRIPTION OF THE INVENTION

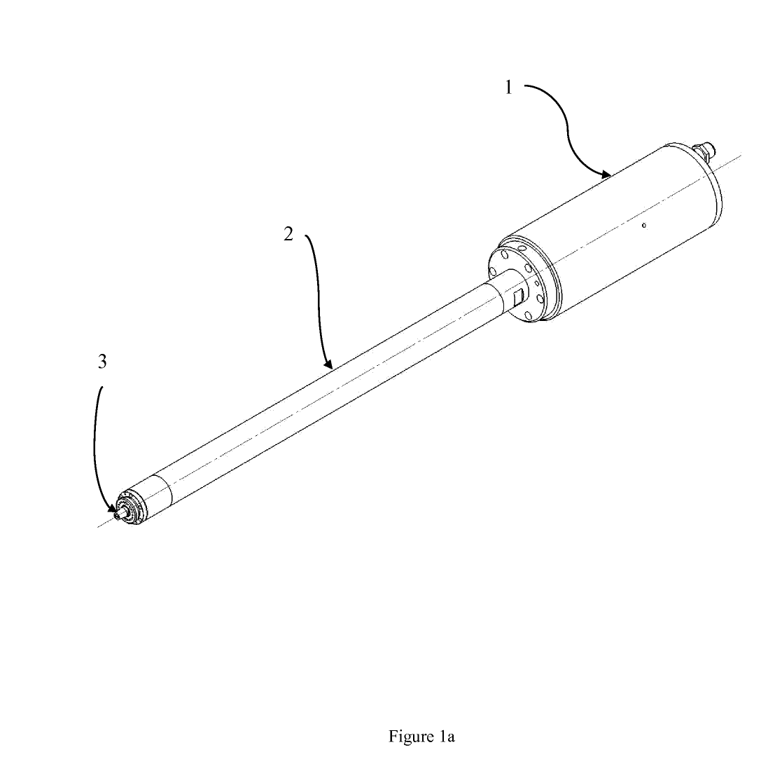

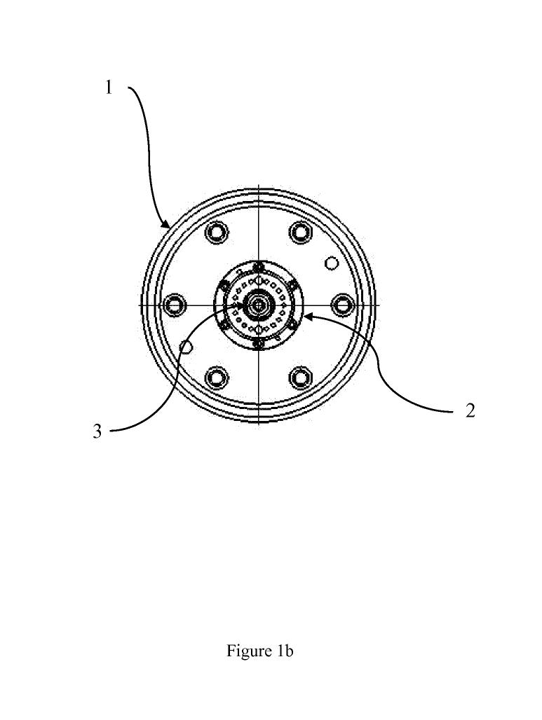

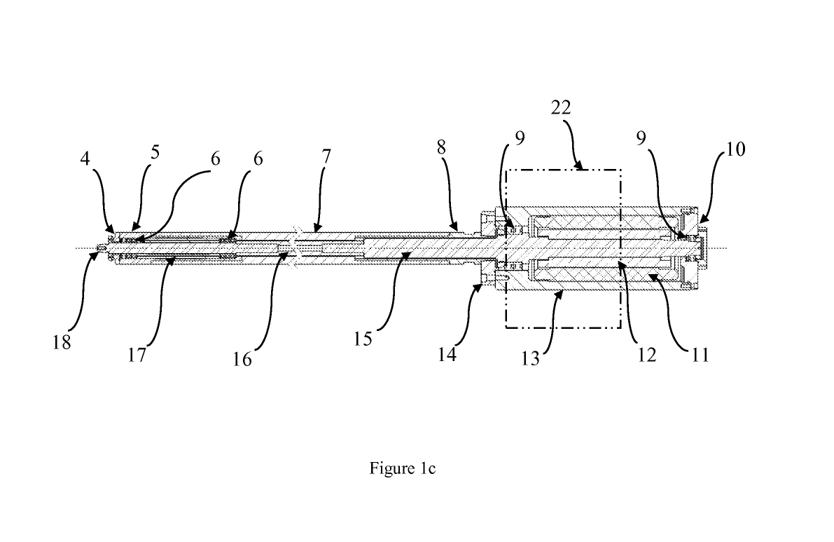

As shown in FIGS. 1a-c, a spindle assembly comprises parts such as a motor housing assembly 1, a spindle housing assembly 2, and an spindle shaft assembly 3. The motor housing 1 is typically used to mount the spindle onto the machining center as shown for reference. The present invention provides an improved spindle housing assembly, and an improved spindle shaft assembly as will be described below.

Referring now to FIG. 1c, the spindle assembly section includes a front nose 18 where typically a tool retention system is used to attach the material removing tool such as a grinding wheel or other traditional metal removing tools, a front cap 4 intended to contain the bearing system and to prevent foreign bodies to contaminate the bearing system, a front insert 5 of the composite material spindle housing, a set of front bearings 6, a set of bearing spacers 17, a composite material spindle housing insert 7, a composite material spindle shaft insert 16, a rear section body of the spindle shaft 15, a rear section body of the spindle housing 8, a set of rear bearings 9, a section body of the spindle housing 14 intended to attach the spindle housing onto the motor housing, a motor housing 13, a motor rotor 12, a motor stator 11, and an end cap 10 to enclose the bearing system and the motor system and to prevent foreign bodies from contaminating the bearing system and the motor system.

### Method of Engineering and Selection

An example of the method for designing and engineering a composite material for the invention is provided, where the process for the fabrication of the composite material is filament winding. Filament winding is a process where the reinforcing fibers are wetted with the matrix material and then are wound around a mandrel of specified size. The orientation and the tension of the fibers are controlled to obtain the final product, as is known in the art. After the winding of the fibers is the curing of the matrix which is usually done in a temperature controlled oven and this process is critical for the overall performance of the final product. The theory involved in this filament winding process is the laminated plate or shell theory.

Laminated composites are sheets of individual plies or lamina bond together with different fiber orientations, as is known in the art. The laminated composite properties vary with the orientation of the fibers. The lamina theory is based on the general (3D) form of Hook's law:

σᵢⱼ=Cᵢⱼₖₗεₖₗ

In this formula, Cᵢⱼₖₗ are the elastic constants (stiffness), εₖₗ is the strain, and there are 81 different constants in the 3D form of the formula. The following formulas are derived from Hook's law and show the change of modulus with the change of the angle. In the formulas, S is the compliance and C is the stiffness

$$\frac{1}{{E}_{xlamina}} = \frac{1}{{E}_{11}} {C}^{4} + [ \frac{1}{{G}_{12}} - \frac{2 {v}_{12}}{{E}_{11}} ] {S}^{2} {C}^{2} + \frac{1}{{E}_{22}} {S}^{4}$$

$$\frac{1}{{E}_{ylamina}} = \frac{1}{{E}_{11}} {S}^{4} + [ \frac{1}{{G}_{12}} - \frac{2 {v}_{12}}{{E}_{11}} ] {S}^{2} {C}^{2} + \frac{1}{{E}_{22}} {S}^{4}$$

$$\frac{1}{{G}_{xylamina}} = 2 [ \frac{2}{{E}_{11}} + \frac{2}{{E}_{22}} + \frac{2 {v}_{12}}{{E}_{11}} - \frac{1}{{G}_{12}} ] {S}^{2} {C}^{2} + \frac{1}{{G}_{12}} [ {C}^{4} + {S}^{4} ]$$

Another derivation from Hook's law is the matrix below which shows the relationship between force (N), momentum (M), constants (A, B and D) strain (ε) and curvature (k).

$$\{ \begin{matrix}{N}_{x} \\ {N}_{y} \\ {N}_{xy} \\ {M}_{x} \\ {M}_{y} \\ {M}_{xy}\end{matrix} \} = [ \begin{matrix}{A}_{11} & {A}_{12} & {A}_{16} & {B}_{11} & {B}_{12} & {B}_{16} \\ {A}_{12} & {A}_{22} & {A}_{26} & {B}_{12} & {B}_{22} & {B}_{16} \\ {A}_{16} & {A}_{26} & {A}_{66} & {B}_{16} & {B}_{26} & {B}_{66} \\ {B}_{11} & {B}_{12} & {B}_{16} & {D}_{11} & {D}_{12} & {D}_{16} \\ {B}_{12} & {B}_{22} & {B}_{26} & {D}_{12} & {D}_{26} & {D}_{26} \\ {B}_{16} & {B}_{26} & {B}_{66} & {D}_{16} & {D}_{26} & {D}_{66}\end{matrix} ] \{ \begin{matrix}{ɛ}_{x}^{0} \\ {ɛ}_{y}^{0} \\ {γ}_{xy}^{0} \\ {κ}_{x} \\ {κ}_{y} \\ {χ}_{xy}\end{matrix} \}$$

The short version of the above formula is the following:

$$\{ \begin{matrix}N \\ M\end{matrix} \} = [ \begin{matrix}A & C \\ B & D\end{matrix} ] \{ \begin{matrix}{ɛ}^{0} \\ κ\end{matrix} \}$$

### Where:

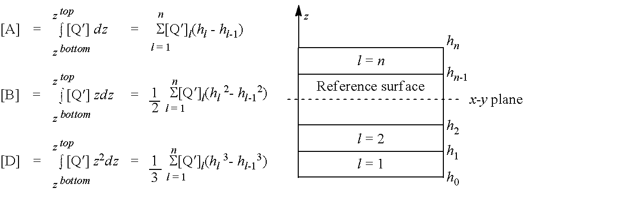

Where N is the force, M is the moment, A is the extensional stiffness, B is the coupling stiffness and D is the bending stiffness. We can see that the resultant stress “is a function of the mid-plane tensile strains (e⁰ₓ and e⁰_{y}), the mid-plane shear strain (Y_{xy}), the bending curvatures (Kₓ and K_{y}), and the twisting (X_{xy})”.

The above theory is based on few basic assumptions which are:
The thickness of the lamina is very small compared to the sides
The bond between two lamina is a perfect bond (without slide between them)
The inter-laminar shear strains are negligible since in-plane displacements are proportional to the thickness (Kirchoff assumption).

The composite material for each the spindle and housing will have characteristics such as reinforcing fiber type, volume percentage of reinforcing fiber, orientation of reinforcing fiber, size of reinforcing fiber, and numbers of layers of reinforcing fibers. Composite materials used to improve the spindle housing and the spindle shaft are obtainable from the following reinforcing fibers: carbon fiber, glass fiber, boron fibers, organic fiber (aramid) ceramic fibers (oxide and non-oxide). In addition, such reinforcing fibers are combined with any of the following matrices to create a tailored composite material: thermoplastic polymers, thermoset polymers, copolymers, metals, ceramics, etc.

The volume percentage for each of the reinforcing fibers types can range from 20%-70%. The orientation for each of the reinforcing fibers types can range from 0° to 90°. The thickness variables of each reinforcing fiber will be 7 μm to 10 μm for carbon fibers, 8 μm to 14 μm for glass fibers; 100 mm to 200 mm for boron fibers; 12 μm for aramid fibers, 20 μm for alumina fibers, 100 μm to 200 μm for silicon-carbide fibers. Variables for reinforcing fibers layers for each of the fiber type may be 4, 6, 8, 12, 16, 20, 24, 30, 36, 42, 48, and 96.

The combination of the matrix type with the reinforcing fiber type, the volume percentage of the reinforcing fiber, the orientation of the reinforcing fiber, the size of the reinforcing fiber, the numbers of layers of such reinforcing fibers, will be adjusted, modified and engineered for each specific spindle application using analysis software such as FEA software, Solidworks Simulation, ANSYS, Nastran or other similar software. The analysis performed for each characteristic of the spindle and the housing is done simultaneously to improve the overall performance.

The improved performance is due to the ability to address individually each specific mechanical characteristics the spindle is required to perform which is not available with spindles created with traditional methods. For instance, the use of composite material on only one of the components of the spindle give the total of 5 variables. In contrast, here the number of variables on a spindle that uses both components made with composite materials gives a total of 10 variables. For example, if for each characteristic three options are selected: 3 different reinforcing fiber types to choose from (carbon, glass, aramid), 3 Volume percentages to choose from (20%, 40%, 60%), 3 fiber orientations to choose from (0°, 45°, 90°), 3 fiber sizes to choose from (0.002″, 0.005″, 0.010″), and 3 numbers of layers to choose from (4, 8, 16), then a permutation of about 59,049 solutions is achieved to choose from using both parts made of composite materials, against about 243 solutions if using only one composite component. Improved performance in a spindle is achieved when a best fit or match of each characteristic in the composite housing and the composite spindle is found for a specific application. Accordingly, the chances of spindle “survival” improves drastically using matched composite materials in both components. With the use of the previously mentioned software, the convergence of all the characteristics or variable can be calculated to a unique solution, and the best composite material for each the spindle and the housing for a specific application can be found and applied.

Method of selecting composite materials include but are not limited to:
1. Purchasing already commercially available composite materials with specific characteristics which may fit the specific application of the spindle housing and the spindle shaft.
2. Designing and engineering specific composite materials using commercially available finite elements analysis software such as FEA software, Solidworks Simulation, ANSYS, Nastran or other similar software, where by input the characteristics needed for the application, the software will calculate the complete composition of the composite material suited for such spindle application.
3. Designing and engineering specific composite materials using commercially available finite elements analysis software such as FEA software, Solidworks Simulation, ANSYS, Nastran or other similar software, where by input the composition of the composite material, the software will calculate the output of the characteristics of such specified composite material.

The present invention provides many advantages over the prior art such as overall better performance over traditional materials used with spindles. These advantages and improvements may be summarized as reduced weight of the spindle, improved strength of the spindle, improved stiffness of the spindle, reduced expansion of the spindle, and improved fatigue resistance of the spindle.

### Reduced Spindle Weight

The use of composite materials versus traditional materials may reduce the weight of the spindle housing and the spindle shaft up to 5 times compared to traditional steel and up to 1.5 times compared to traditional aluminum. For instance, the weight of composite material may be 2 pounds (Lbs) while that of traditional materials such as steel and aluminum may be 10 and 3 pounds respectively.

The weight of a material is an intrinsic force exerted by the mass and the gravity on the material. The benefits of a spindle with less weight can improve the spindle performance in many different ways, specifically it reduces the spindle nose deflection due to the gravitational force particularly when the spindle is used in a horizontal position. Additional advantage of the weight reduction is notable in the reduced power required to operate the spindle especially in high frequency operations due to a smaller moment of inertia of the spindle, consequently such unused power can be re-applied to increased torque and increased speed. Likewise, due to the reduced weight, less power is required to move the spindle in applications where the spindle is part of a multi-axis machining center and when the spindle is mounted at the end of the multi- axis system. In this case, it is notable to achieve better precision, accuracy and life of the machining center since it is operating with a smaller weight spindle, which represent part of the load the machining center is required to handle.

### Improved Spindle Strength

The use of composite materials versus traditional materials may increase the strength of the spindle housing and the spindle shaft up to 1.8 times compared to traditional steel and up to 2.25 times compared to traditional aluminum . For instance, the strength of composite material may be 3,600 pounds per square inches (PSI) while that of traditional materials such as steel and aluminum may be 2,000 and 1,600 PSI respectively.

Strength in a material is the capacity to withstand stress and strain. The advantages of a spindle with higher strength materials can improve the spindle performance in many different ways, as a higher strength material increases the work that can be done compared to a spindle made of traditional materials with the same geometrical dimensions. Also, a deeper and more aggressive cut may be taken to reduce the working time of the part being manufactured. In addition, stronger material can improve the rigidity of the spindle during the work obtaining a better surface finish by reducing the surface roughness. Also, due to the increased strength, higher power can be applied to the spindle without compromising the accuracy, the precision and the life of the spindle. Similarly, a stronger material may improve the stiffness of the spindle which also contributes to a better surface finish of the product being worked.

### Improved Stiffness of the Spindle

The use of composite materials versus traditional materials may increase the stiffness of the spindle housing and the spindle shaft up to 1.2 times compared to traditional steel and up to 3.42 times compared to traditional aluminum. Stiffness of composite material may be 36,000 pounds per inch (Lbs/in) while that of steel and aluminum may be 30,000 and 10,500 Lbs/in respectively.

Stiffness is the capacity of a material to resist deformations. The advantages of a spindle with higher stiffness improves the spindle performance in many different ways, particularly when there is a need of manufacturing parts with ultra-high precision dimensions and with very close dimensional tolerances. Also an improved surface finish can be achieved with high stiffness spindles. In addition, due to the nature of certain composite materials such as for example carbon fibers reinforcements with a polymer matrices, the stiffness is increased for the aforementioned reasons, without sacrificing the vibrations dampening effect of the spindle. In fact, certain composite materials have increased stiffness and good dampening quality which makes their use in a spindle application an ideal material. The dampening quality of the spindle is needed when there are vibrations caused by the cutting action and shape of the cutting tool, the natural frequencies of the spindles (also called Eigen-frequencies), the bearings defect frequencies and the spindle shaft and spindle housing defects present in the spindle. These intrinsic and residual imperfections generate a residual vibration which can be dampened by the use of certain composite materials. Without good dampening characteristics, vibrations resonance may occur, which introduces the undesired effect of self-amplifying the vibration magnitude until the spindle fails.

### Reduced Thermal Expansion of the Spindle

The use of composite materials versus traditional materials may reduce the thermal expansion of the spindle housing and the spindle shaft up to 10 times compared to traditional steel and up to 21 times compared to traditional aluminum. Thermal expansion of composite material may be 0.6 micro-inches per every inch of length and per every Fahrenheit degree increase of temperature [(min/in)×F°], while that of steel and aluminum may be 6.0 and 1.3 [(min/in)×F°] respectively.

Thermal expansion of a material is the rate in which the material deforms under a temperature change. The advantages of a spindle with reduced thermal expansion can improve the spindle performance in different ways, explicitly a key improvement is notable in the accuracy and precision of the cutting tool, which is affected negatively by the shaft axial thermal expansion. A machining center in which the spindle is mounted (holding the cutting tool), goes through a procedure called “zeroing” in which the exact location of the cutting tool is identified and recorded into the coordinates of the machine. This procedure is executed before the machine center is being used and thus at a certain spindle temperature. During the machining center operation however, if the spindle temperature changes notably, and in that case it generates an axial deformation of the spindle shaft, causing therefore the length variation of the shaft itself and consequently the misallocation of the tool in which it is attached to, displacing the tool from the initial position previously set. As the temperature changes, so does the location of the tool causing undesired results on the quality of the machining A spindle with a specific composite material diminishes the thermal deformation defects drastically compared to a traditional spindle.

### Improved Fatigue Resistance of the Spindle

The use of composite materials versus traditional materials may increase the fatigue resistance of the spindle housing and the spindle shaft up to 2 times compared to traditional steel and up to 2.87 times compared to traditional aluminum. For instance, fatigue resistance of the composite material may be 2,000,000 load cycles while that of steel and aluminum are 1,000,000 and 700,000 respectively.

Fatigue is the premature failure of a material under cycling loading even if the applied load does not reach the allowed yield strength of such material. The advantages of a spindle with increased fatigue resistance can improve the spindle performance in many different ways, specifically when the spindle undergoes a cyclical load where the load is variable and applied cyclically such as when the cutting tool used on the spindle is an end mill, a surface mill, and any other tool in which pronounced cutting teeth are present. In such conditions the traditional material may fail prematurely even if the magnitude of the load applied is lower than the maximum yield strength of such material. The use of specific composite materials increases the overall life of the spindle and therefore lessens maintenance costs and diminishes spindle replacements.

The spindle of the present invention is designed and analyzed using a holistic approach. Here the composite materials used at each the housing and the shaft are tailored to achieve an improved overall spindle performance. A composite material spindle housing insert and a composite material spindle shaft insert is prepared by simultaneously designing and engineering specific composite materials for each. The composite material of the spindle housing insert has a fiber type, volume percentage, orientation, thickness and layer that is calculated by the software to match a fiber type, volume percentage, orientation, thickness and layer of the composite material of the spindle shaft insert. The calculations of each the housing and shaft are used to determine the interaction of each for optimum performance. Optimum spindle performance results in reduced spindle weight, improved strength, improved stiffness, reduced thermal expansion and improved fatigue resistance.

### EXAMPLES

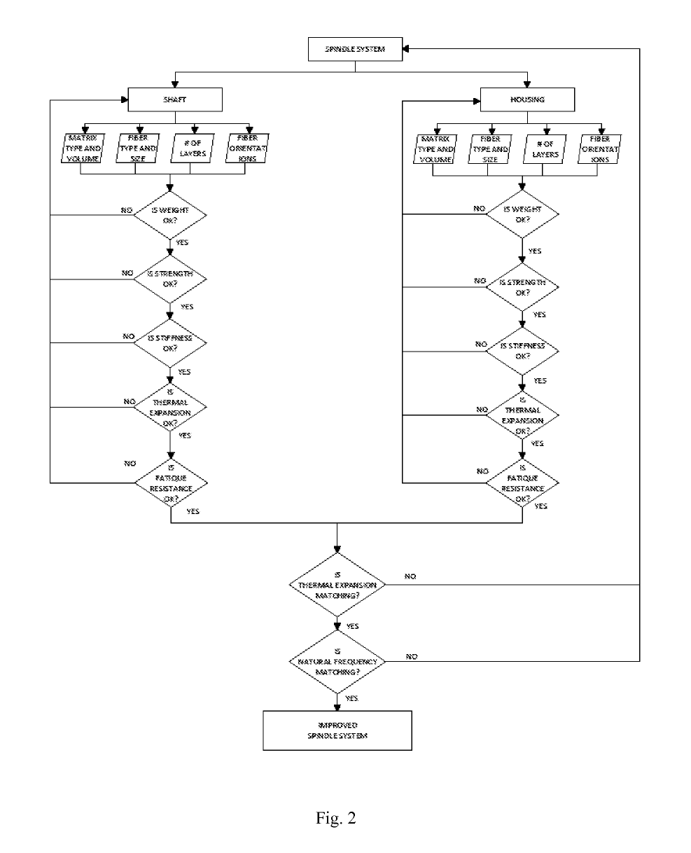

FIGS. 2-4 show flowcharts providing examples of improvements made to a spindle after the shaft and the housing are both optimized for proper performance via an interaction analysis by the spindle system 100. Optimization occurs by simultaneously analyzing the shaft and housing to achieve improvements in both.

From the beginning of the analysis performed by spindle system 100 both the shaft 300 and housing 200 are analyzed for its ultimate intended purpose. The shaft 300 is analyzed for mechanical characteristics such as volume percentage, matrix type and volume 310, reinforcing fiber type and size of reinforcing fiber 320, number of reinforcing fiber layers 330, and orientation of reinforcing fibers 340. Likewise, the housing 200 is analyzed for the same mechanical characteristics volume percentage, matrix type and volume 210, reinforcing fiber type and size of reinforcing fiber 220, number of reinforcing fiber layers 230, and orientation of reinforcing fibers 240. The characteristics for both the shaft and housing are adjusted, modified, and engineered simultaneously using analysis software for specific spindle applications. After simultaneously analyzing the shaft 300 and housing 200 the spindle is checked for reduced weight 350, 250, improved spindle strength 360, 260, improved spindle stiffness 370, 270, reduced thermal expansion of the spindle 380, 280 and reduced fatigue resistance of the spindle 390, 290. If any of the elements 350, 250, 360, 260, 370, 270, 380, 280 and 390, 290 are not reduced or improved, as desired, then the process restarts, performing again the analysis of mechanical characteristic for both the shaft 300 and the housing 200.

After the system 100 analyzes the shaft 300 and housing 200 for optimized performance, the spindle is analyzed for a variety of improvements some of which are explained and shown in FIGS. 2-4. FIG. 2 shows the steps taken to match thermal expansion and match natural frequencies in each the shaft and housing. In FIG. 2, the optimized spindle is tested to determine if the thermal expansion of the shaft matches the thermal expansion of the housing 400. If there is a match the next step is to evaluate whether the natural frequency matches 500. A match between the natural frequency of the shaft and the natural frequency of the housing results in an improved spindle system 1000. Failure to achieve a match in the thermal expansion 400 or the natural frequency 500 causes the system 100 to restart.

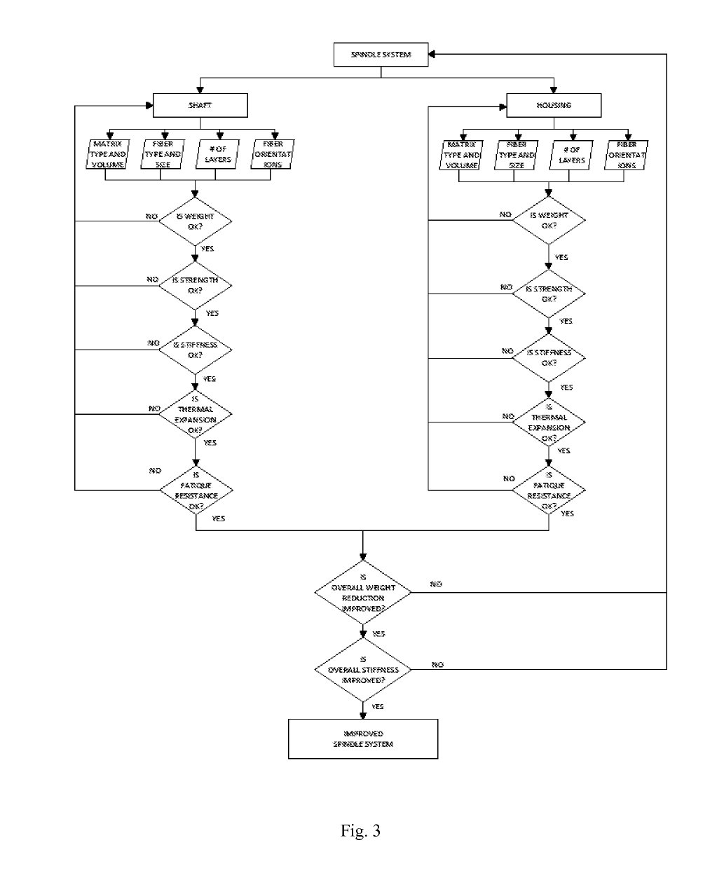

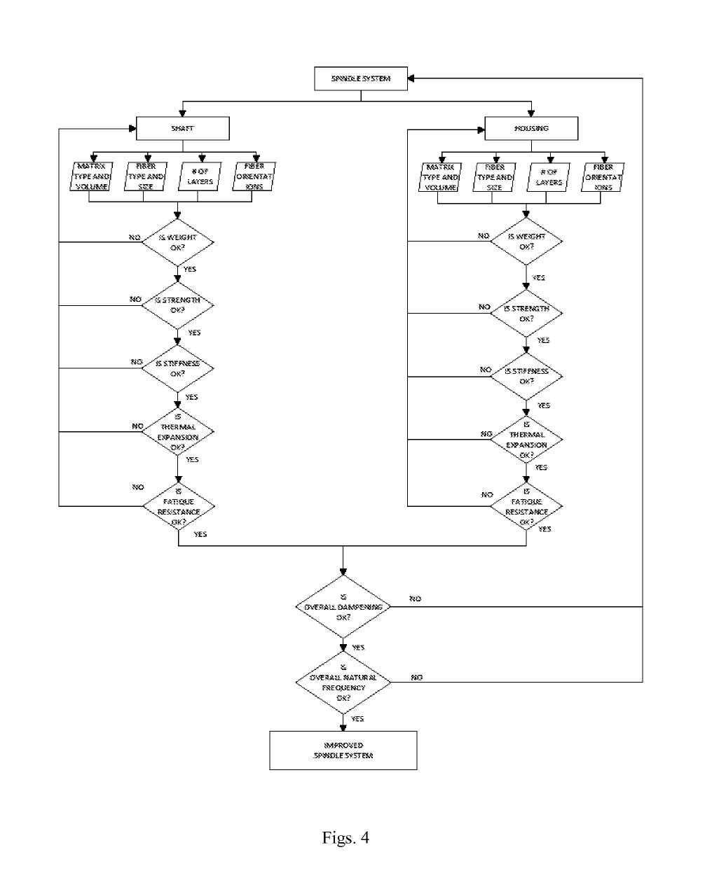

FIG. 3 shows the optimized spindle is analyzed for improvements in further weight reduction 600 and improved overall stiffness 700. If the weight for both the shaft 300 and housing 200 is reduced 600 and the stiffness 700 for the shaft and housing is improved then an improved spindle system 1000 is produced. If either or both the weight increases or the stiffness deteriorates for each the shaft and housing then the system 100 restarts. FIG. 4 provides analysis of overall dampening 800 and overall natural frequency ranges 900 for each the shaft and housing in the improved spindle. Similar to the above, if the dampening quality 800 in both the shaft and housing is improved and the natural frequency ranges 900 shows improved control in both the shaft and housing then an improved spindle system 1000 is produced. However, if either or both dampening quality 800 decreases or the natural frequency ranges 900 shows poorer control 900 then the system 100 restarts.

For each example in FIGS. 2-4 once the mechanical characteristics of the shaft 300 and housing 200 are simultaneously analyzed the spindle is further analyzed for spindle improvements. Like the analysis conducted for mechanical characteristics, the improvements analysis or computation of optimum spindle performance is performed simultaneously by comparing the housing to the shaft for spindle improvements. As mentioned above, the spindle improvements include but are not limited to evaluation of spindle weight, spindle strength, spindle stiffness, thermal expansion and fatigue resistance.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A spindle comprising:
a composite material spindle housing insert, said spindle housing insert having housing characteristics of a housing fiber type, housing fiber volume percentage, housing fiber orientation, housing fiber thickness and housing fiber layers; and
a composite material spindle shaft insert, said spindle shaft insert having spindle characteristics of a shaft fiber type, shaft fiber volume percentage, shaft fiber orientation, shaft fiber thickness and shaft fiber layers,
wherein the housing characteristics are calculated to match the spindle characteristics to provide optimum spindle performance.

2. The spindle of claim 1 wherein said optimum spindle performance includes reduced spindle weight, improved strength, improved stiffness, a reduced thermal expansion and improved fatigue resistance.

3. The spindle of claim 1 wherein the calculations are performed using analysis software.

4. The spindle of claim 1 wherein the analysis software includes FEA software, Solidworks Simulation, ANSYS, and Nastran.

5. A spindle comprising:
a composite material spindle housing insert, said spindle housing insert having housing characteristics of a housing fiber type, housing fiber volume percentage, housing fiber orientation, housing fiber thickness and housing fiber layers; and
a composite material spindle shaft insert, said spindle shaft insert having spindle characteristics of a shaft fiber type, shaft fiber volume percentage, shaft fiber orientation, shaft fiber thickness and shaft fiber layers,
wherein the housing characteristics are calculated simultaneously to match the spindle characteristics to provide optimum spindle performance.

6. A method for determining optimum spindle performance comprising:
simultaneously comparing housing characteristics of a composite material spindle housing insert to spindle characteristics of a composite material spindle shaft insert, wherein said housing characteristics include housing fiber type, housing fiber volume percentage, housing fiber orientation, housing fiber thickness and housing fiber layers and said spindle characteristics include shaft fiber type, shaft fiber volume percentage, shaft fiber orientation, shaft fiber thickness and shaft fiber layers; and
subsequently, computing optimum spindle performance by simultaneously comparing said composite material spindle housing insert and said composite material spindle shaft insert for spindle improvements, wherein said spindle improvements include evaluation of spindle weight, spindle strength, spindle stiffness, thermal expansion and fatigue resistance,
wherein said spindle improvements exist if said composite material spindle housing insert and said composite material spindle shaft insert are improved compared to each other,
wherein said spindle improvements do not exist if said composite material spindle housing insert and said composite material spindle shaft insert do not improve when compared to each other.
